(19) United States
(12) Patent Application Publication
(10) Pub. No.: US 2019/0118090 A1
(43) Pub. Date: Apr. 25, 2019

(54) MANAGEMENT & ASSEMBLY OF INTERDEPENDENT CONTENT NARRATIVES

(71) Applicant: Sony Interactive Entertainment LLC, San Mateo, CA (US)

(72) Inventor: Warren M. Benedetto, Aliso Viejo, CA (US)

(21) Appl. No.: 15/788,569

(22) Filed: Oct. 19, 2017

(51) Int. Cl. A63F 13/63; A63F 13/95; A63F 13/52; A63F 13/54

(52) U.S. Cl. CPC A63F 13/63; A63F 13/54; A63F 13/52; A63F 13/95

(57) ABSTRACT

Systems and methods for management and assembly of interdependent content narratives are provided. A narrative map may be stored in memory, which identifies a plurality of decision outcomes available at a decision point within an interactive content title where each decision outcome is associated with a set of narrative elements of an interdependent content title. Tracked data regarding interaction by a player with the interactive content title may identify when the decision point has been reached in a session, as well as a selected decision outcome. The narrative elements of the interdependent content title may be filtered based on the selected decision outcome and the stored narrative map. An episode of the interdependent content title may be assembled based on the filtered set of narrative elements associated with the selected decision outcome as indicated by the stored narrative map. The player may then be provided with access to the assembled episode.

### BACKGROUND OF THE INVENTION

### 1. Field of the Invention

The present invention generally relates to content management. More specifically, the present invention relates to management and assembly of interdependent content narratives.

### 2. Description of the Related Art

Some presently available types of content may be interactive, whereby a consumer may influence outcomes in the narrative of the content. Such interactive content may allow for certain choices to be made by the consumer and may be responsive to different choices in different ways. A typical example of interactive content may be a game, such as a video game, online game, or gamebook (e.g., a “Choose Your Own Adventure” book). While references herein may be made specifically to a game or game title, such reference should be understood to encompass any variety of different types of interactive content known in the art. While a game title may begin with a certain premise, the narrative of such game title may be differ from session to session based on different choices and skill level of the player. For example, different players may opt to use different avatars, develop different in-game abilities, and fight different battles, as well as succeed in each endeavor to different extents. The narratives of such types of interactive content may therefore be driven primarily by the player. The decisions made within such an interactive content title only have consequences within the context of that content title, however.

Other types of content are not interactive, however. Such non-interactive content do not require input from the content consumer for the narrative to advance. On the contrary, the narrative of a non-interactive content title is authored well in advance of publication or distribution to the consumer, and as such, is predetermined by the time the consumer encounters the same. Video content (e.g., movies, television/episodic shows), most books, and different forms thereof (e.g., audio books) are generally not interactive with respect to their particular narrative. Moreover, such content may require significant lead time and other resources to be authored, filmed (or animated, in the case of animated video), edited, and otherwise produced.

Notwithstanding, there is a market for tie-in works associated with popular content. For example, a popular movie (e.g., Star Wars) may be associated with a video game title (e.g., Star Wars: Battlefront) whose premise is related to the narrative of the movie. The video game title may take place in the same fictional universe, for example, during similar timeframes and informed by the same events and other establishing elements of that universe. The game player may select an avatar that may be related to the characters of the movie. The choices made within the video game title, however, only have consequences within the video game narrative. No decision or outcome within Star Wars: Battlefront, for example, has any effect on the events that take place within Star Wars the movie. One difficulty preventing interdependent narratives is the lack of integration or connection between current systems for content generation and current systems for content interaction.

There is, therefore, a need in the art for improved systems and methods for management and assembly of interdependent content narratives.

### SUMMARY OF THE CLAIMED INVENTION

Embodiments of the present invention allow for management and assembly of interdependent content narratives. A narrative map may be stored in memory, which identifies a plurality of decision outcomes available at a decision point within an interactive content title where each decision outcome is associated with a set of narrative elements of an interdependent content title. Tracked data regarding interaction by a player with the interactive content title may identify when the decision point has been reached in a session, as well as a selected decision outcome. The narrative elements of the interdependent content title may be filtered based on the selected decision outcome and the stored narrative map. An episode of the interdependent content title may be assembled based on the filtered set of narrative elements associated with the selected decision outcome as indicated by the stored narrative map. The player may then be provided with access to the assembled episode.

Various embodiments of the present invention may include systems for management and assembly of interdependent content narratives. Such systems may include a content server that stores a narrative map identifying a plurality of decision outcomes available at a decision point within an interactive content title where each decision outcome associated with a set of narrative elements of an interdependent content title, an interactive content server that tracks data regarding interaction by a player device with the interactive content title to identify when the decision point has been reached in a session, and a content generation server that identifies that the tracked data is indicative of a selected decision outcome from the plurality of available decision outcomes, filters the narrative elements of the interdependent content title based on the selected decision outcome and the stored narrative map, assembles an episode of the interdependent content title based on the filtered set of narrative elements associated with the selected decision outcome as indicated by the stored narrative map, and provides the player device with access to the assembled episode in response to a request from the player device.

Further embodiments of the present invention may include methods for management and assembly of interdependent content narratives. Such methods may include storing a narrative map in memory identifying a plurality of decision outcomes available at a decision point within an interactive content title where each decision outcome associated with a set of narrative elements of an interdependent content title, tracking data regarding interaction by a player with the interactive content title to identify when the decision point has been reached in a session, identifying that the tracked data is indicative of a selected decision outcome from the plurality of available decision outcomes, filtering the narrative elements of the interdependent content title based on the selected decision outcome and the stored narrative map, assembling an episode of the interdependent content title based on the filtered set of narrative elements associated with the selected decision outcome as indicated by the stored narrative map, and providing the player with access to the assembled episode in response to a request from the player.

Yet further embodiments of the present invention may include non-transitory computer-readable storage media having embodied thereon a program executable by a processor to perform a method for management and assembly of interdependent content narratives as described above.

### BRIEF DESCRIPTIONS OF THE DRAWINGS

FIG. 1 illustrates a network environment in which a system for management and assembly of interdependent content narratives may be implemented.

FIG. 2A illustrates an exemplary narrative map with a set of decision points that may be available in an interactive content title.

FIG. 2B illustrates an exemplary narrative of content that may be assembled based on a set of decisions made with respect to the decision points in the narrative map of FIG. 2A.

FIG. 2C illustrates another exemplary narrative of content that may be assembled based on a different set of decisions made with respect to the decision points in the narrative map of FIG. 2A.

FIG. 3 is a flowchart illustrating an exemplary method for management and assembly of interdependent content narratives.

FIG. 4 is an exemplary electronic entertainment system that may be used in management and assembly of interdependent content narratives.

### DETAILED DESCRIPTION

Embodiments of the present invention allow for management and assembly of interdependent content narratives. A narrative map may be stored in memory, which identifies a plurality of decision outcomes available at a decision point within an interactive content title where each decision outcome is associated with a set of narrative elements of an interdependent content title. Tracked data regarding interaction by a player with the interactive content title may identify when the decision point has been reached in a session, as well as a selected decision outcome. The narrative elements of the interdependent content title may be filtered based on the selected decision outcome and the stored narrative map. An episode of the interdependent content title may be assembled based on the filtered set of narrative elements associated with the selected decision outcome as indicated by the stored narrative map. The player may then be provided with access to the assembled episode.

Interdependency as used herein refers to customization of a story for an individual player based on decisions (or other outcomes) made by that player with respect to an associated game. Such interdependent stories may be presented using any type of digital media known in the art, including video (e.g., animated or live-action movie or episodic series), audio, electronic books, electronic comics, and any combination of the foregoing. As such, references to interdependent stories should be understood broadly to encompass any type of digital media known in the art.

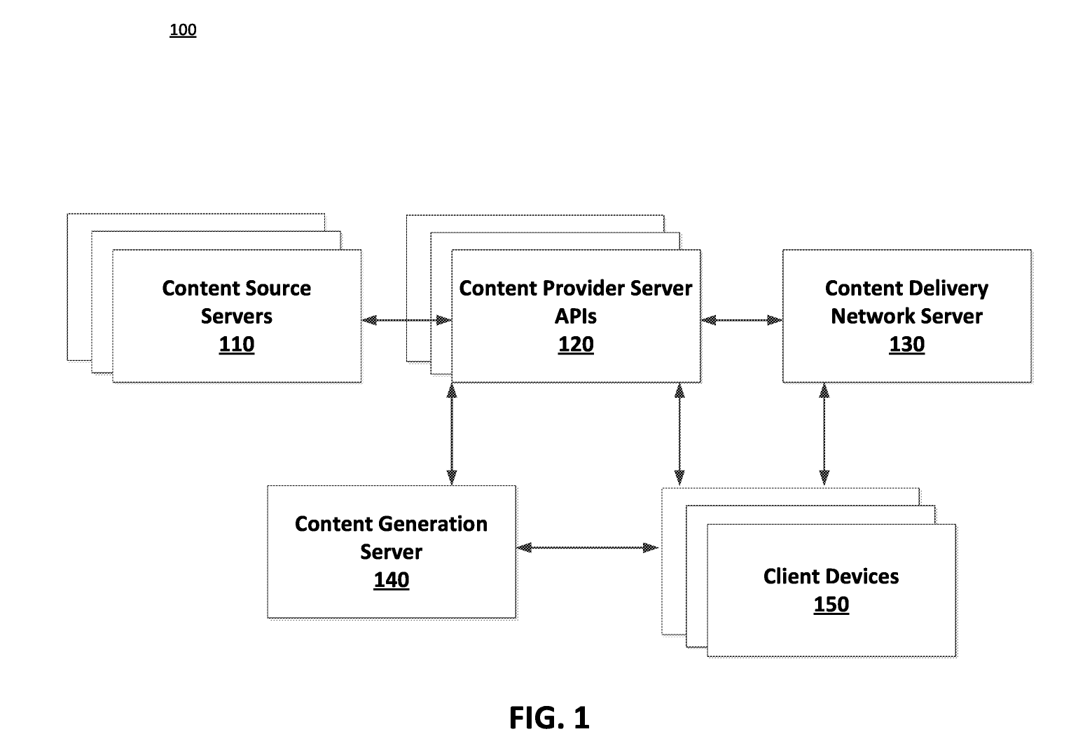

FIG. 1 illustrates a network environment 100 in which a system for management and assembly of interdependent content narratives may be implemented. The network environment 100 may include one or more content source servers 110 that provide digital content (e.g., movies, television/episodic shows, electronic books/ comics) for distribution (e.g., via one or more video on-demand (VOD) services), one or more content provider server application program interfaces (APIs) 120, content delivery network server 130, a content generation server 140, and one or more client devices 150.

Content source servers 110 may maintain and provide a variety of content and media titles available for distribution. The content source servers 110 may be associated with any content provider that makes its content available for access over a communication network. Such content may include movies, television/episodic shows, electronic books/comics, etc. In addition to traditional forms of such media, content source servers 110 may further maintain content titles with whose narratives are interdependent on external factors.

Each interdependent story may be associated with an interactive content (e.g., game) title and may be inclusive of a plurality of alternative narrative elements that may be assembled in a variety of different combinations based on events within the game title. While collectively referred to as a single content title (or story), an interdependent content title (or interdependent story) may encompass multiple different narratives (e.g., parallel universes or alternate universes) that may differ in small or significant ways.

The particular set of narrative elements selected for each combination may be based on choices, achievements, or other events or statuses specific to the individual consumer of the content title. Such an interdependent story provided to content source server 110 may be associated with a game title, specifically with identified decision points within the game title. Each decision point may allow for multiple different choices or outcomes. Each outcome is further associated with a different set of narrative elements that may be used to assemble a defined portion of the interdependent story. As used herein, episode may be inclusive of any defined portion of any content title, such as a portion of a movie, an episode of a television show or miniseries, a chapter of an electronic book, or issue of an electronic comic. For example, the interdependent story may be divided into ten consecutive episodes. There may, however, be multiple different versions of each episode that are possible. A particular interdependent story may have numerous different possible variations for its first episode that may be assembled based on decision outcomes in the associated game title. A particular player may play the game title through to the last decision point and be given access to a first version of a set of ten episodes. A different player—or the same player making different choices—may be given access to a different version of the set of ten episodes.

The relationship between the game title and the interdependent story may be defined by a narrative map. Such a narrative map may identify a plurality of decision points within the game title. Each decision point may allow for multiple possible outcomes, each of which is associated with a different set of narrative elements of the interdependent story. Making different choices at the decision point may therefore result in a different narrative or storyline. While the interdependent relationship to different decision outcomes made in a separate game title results in various differences, the different alternative narratives that are possible within the interdependent story may also share some common elements. The narrative map may further be defined based on one or more exclusionary rules that exclude certain narrative elements from a storyline so as to maintain consistency and continuity of events. For example, an exclusionary rule may prevent narrative elements involving a dead character from being included in a later episode.

Each set of narrative elements may represent a different storyline that may result from the decision outcomes selected or otherwise determined within the game title. Such narrative elements may include a variety of alternative visual elements, audio elements, environmental elements, character elements, or plot elements. For example, a narrative element may include the continued existence of a character that may or may not be killed within the game title. Where the character has been killed in the game title, the alternative variations still available for the interdependent story may be filtered to remove narrative elements—including character elements and plot elements—that involve or depend upon the continued presence of that character.

Other character-based narrative elements may include aspects related to appearance, attitudes (e.g., love/hate meter), health, skills/abilities, and resources. Actions within an interactive game in relation to an in-game character may affect how likely that character will be to help or hurt another character in the interdependent story. Different partnerships, teams, feuds, and conflicts in the interdependent story may result, for example, from different actions in the game title that may instigate, build, destroy, or otherwise affect relationships between characters. Storylines involving love triangles (or other polygons) may result in different couples, no couple at all, or a polyamorous group. Crises of conscience may result in different path choices (e.g., resisting or turning to the dark side). One set of decision point outcomes may result in disaster and tragedy, while a different set of decision point outcomes may result in a happily-ever-after ending.

The extent of the decision point outcomes may not necessarily be significant to the outcome of the game title in order to have significant effect on the interdependent story, and vice versa. For example, selecting a path among multiple available paths within the environment of the interactive game title may not have great significance (e.g., with respect to score, winning/losing) within that interactive game title, but may be used as a basis for filtering out narrative elements in the interdependent story that significantly affects the respective directions and features of the remaining alternative variations. Different players who end their respective interactive game session with similar results (e.g., scores, levels) may nevertheless be provided with different interdependent content narratives based on their respective different decision point outcomes.

Another narrative element may be an environmental background element (e.g., alternative skins applied to objects, characters, background elements), the appearance of which may be based on what decision point outcome is selected or achieved. For example, the appearance of a building within an interdependent story may be damaged (e.g., burned, blackened, bullethole-ridden, windows broken, graffiti) to varying degrees based on actions taken in the associated game title. Characters may change clothing, accessories, hair/makeup, injury (e.g., black eyes, bruising, amputations), body modifications (e.g., tattoos, wings, cybernetic limbs), avatar-specific features, etc.

The content from content source server 110 may be provided through a content provider server API 120, which allows various types of content sources server 110 to communicate with other servers in the network environment 100 (e.g., content generator server 140). The content provider server API 120 may be specific to the particular language, operating system, protocols, etc. of the content source server 110 providing the content. In a network environment 100 that includes multiple different types of content source servers 110, there may likewise be a corresponding number of content provider server APIs 120 that allow for various formatting, conversion, and other cross-device and cross-platform communication processes for providing content to different client devices 150, which may use different content media player application to play such content. As such, content titles of different formats may be made available so as to be compatible with client device 150.

In some embodiments, the source or developer of a game title may be different from the source or producer of an interdependent story. Moreover, the relationship between a game title and an interdependent story may be revised and updated over time. Such revisions and updates may be made by reference to the narrative map associated with the interdependent story, and may further include new narrative elements and new combinations of the same.

The content provider server API 120 may further facilitate access of each of the client devices 150 to the content hosted by the content source servers 110, either directly or via content delivery network server 130. Additional information, such as metadata, about the accessed content can also be provided by the content provider server API 120 to the client device 150. As described below, the additional information (i.e. metadata) can be usable to provide details about the content being provided to the client device 150. Finally, additional services associated with the accessed content such as chat services, ratings and profiles can also be provided from the content source servers 110 to the client device 150 via the content provider server API 120.

Moreover, content provider server API 120 may also facilitate receipt and interpretation of data received from client devices 150. Such data from client devices 150 may include data regarding the outcomes of decision points within a game title being played at a particular client device 150. Such outcomes may be based on selection made by an individual player of the game title at the client device 150, a player achievement within the game title, or another parameter (e.g., geographic location, profile information, in-game status) specific to the player, or a combination thereof. The information regarding the decision point outcomes may therefore be provided to content generation server 140—whether directly or indirectly via one or more of content provider server APIs 120 and content delivery network server 130—for use in filtering the narrative elements of the associated interdependent story.

The content delivery network server 130 may include a server that provides resources and files related to either game titles or interdependent stories, including promotional images and service configurations with client devices 150. The content delivery network server 130 can also be called upon by the client devices 150 that request to access specific content. Content delivery network server 130 may include game servers, streaming media servers, servers hosting downloadable content, and other content delivery servers known in the art.

The content provider server API 120 may communicate with a content generation server 140 in order to process interdependent stories for the client device 150. As described herein, content generation server 140 may receive information regarding decision point outcomes arising in game titles played by a player of a client device 150. Such information regarding the decision point outcomes may be used to filter among the available narrative element of an associated interdependent story provided via content source server 110.

As noted herein, interdependent stories may be associated with metadata specifying how narrative elements of such interdependent stories may be filtered and assembled for a specific player of a game title. Such metadata may be part of a narrative map that identifies relevant decision points within the game title, identifies the available outcomes of each decision point, and identifies the narrative elements associated with each outcome and how such narrative elements are to be assembled. Such narrative map may further identify a location where each selected narrative element is stored (e.g., URL) at the content source server 110 for retrieval and how such narrative element is to be assembled into a player-specific interdependent content narrative. Furthermore, the metadata and narrative map may include details about the interactive and/or interdependent stories (e.g., decision point outcomes, interdependent content narrative), as well as instructions for implementing functionalities (e.g., chat) that would allow different client devices 150 to interact with each other in relation to their respective interdependent content narratives that have been assembled for each client device 150.

The content generation server 140 may therefore communicate with the different content source servers 110 in order to retrieve a set of narrative elements and process such narrative elements for a particular client device 150 (and its decision point outcomes). The content generation server 140 may carry out instructions, for example, for identifying the set of narrative elements of the interdependent stories that is associated with the decision point outcomes of the game title and assembling the identified set of narrative elements so as to be playable as a defined episode on the client device 150. As noted herein, the interdependent story may be customized or made dependent on decisions, events, or other types of outcomes in a game title. The interdependent story may be divided into defined portions or episodes, each of which may be based on one or more decision point outcomes. Because an episode may require such decision point outcomes in order to identify which set of narrative elements to assemble together, a player may not access that episode or defined portion until the required decision point outcomes have been determined within the game title. A player who requests an episode before the requisite decision point outcomes have occurred may therefore be denied access to such episode. In some embodiments, a player may be provided access to a storyline and alternative storylines without having to play or replay the associated game session. Such access may be purchased, earned (e.g., based on in-game or network status), or provided as a bonus or reward.

Content generation server 140 may also use a variety of different techniques for assembling different narrative elements together into an episode. Depending on the type of narrative element (e.g., visual, audio, background, character, or plot), the set of techniques may vary from episode to episode. Various visual effects image manipulation techniques may be used, for example, to incorporate selected visual elements together. For example, green screen techniques may be used to composite different images together, including changing backgrounds, character clothing, or other image portions. The specific image being incorporated into an episode may be based on the associated decision point outcome. Other narrative elements may be incorporated as alternative video clips (or electronic book chapters) that may be combined with other video clips (or chapters) to constitute an episode.

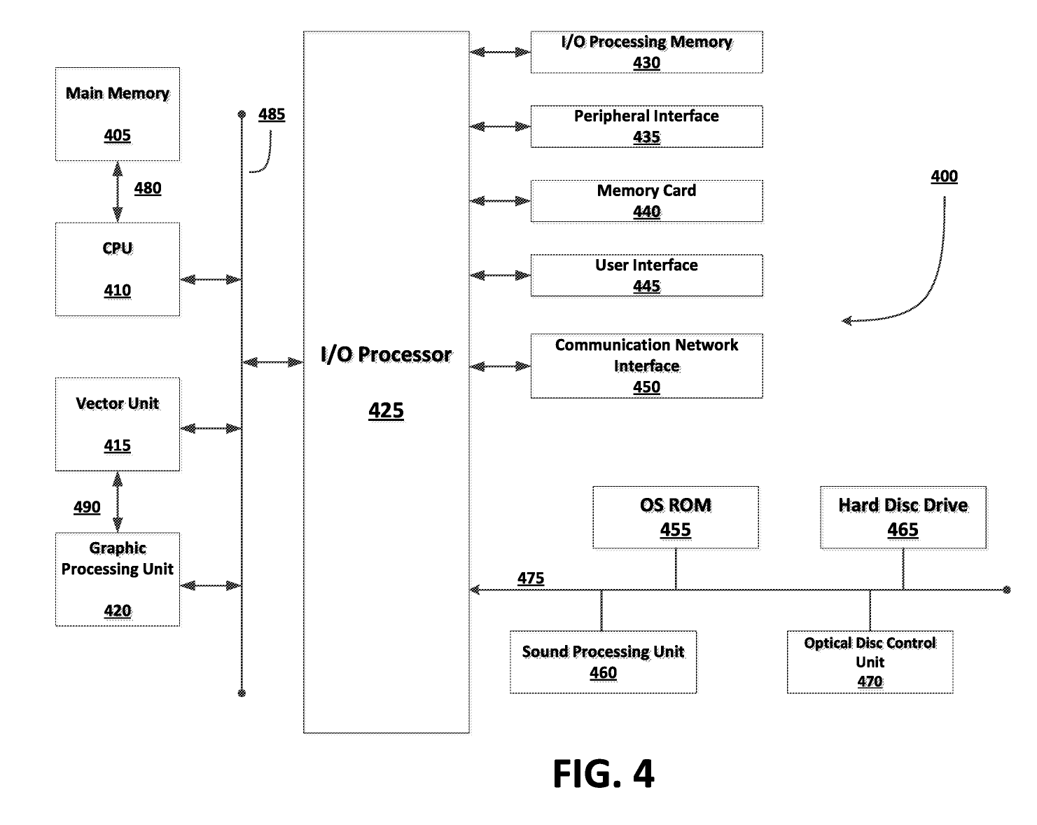

The client device 150 may include a plurality of different types of computing devices. For example, the client device 150 may include any number of different gaming consoles, mobile devices, laptops, and desktops. A particular player may be associated with a variety of different client devices 150. Each client device 150 may be associated with the particular player by virtue of being logged into the same player account. Such client devices 150 may also be configured to access data from other storage media, such as, but not limited to memory cards or disk drives as may be appropriate in the case of downloaded services. Such devices 150 may include standard hardware computing components such as, but not limited to network and media interfaces, non-transitory computer-readable storage (memory), and processors for executing instructions that may be stored in memory. These client devices 150 may also run using a variety of different operating systems (e.g., iOS, Android), applications or computing languages (e.g., C++, JavaScript). An exemplary client device 150 is described in detail herein with respect to FIG. 4.

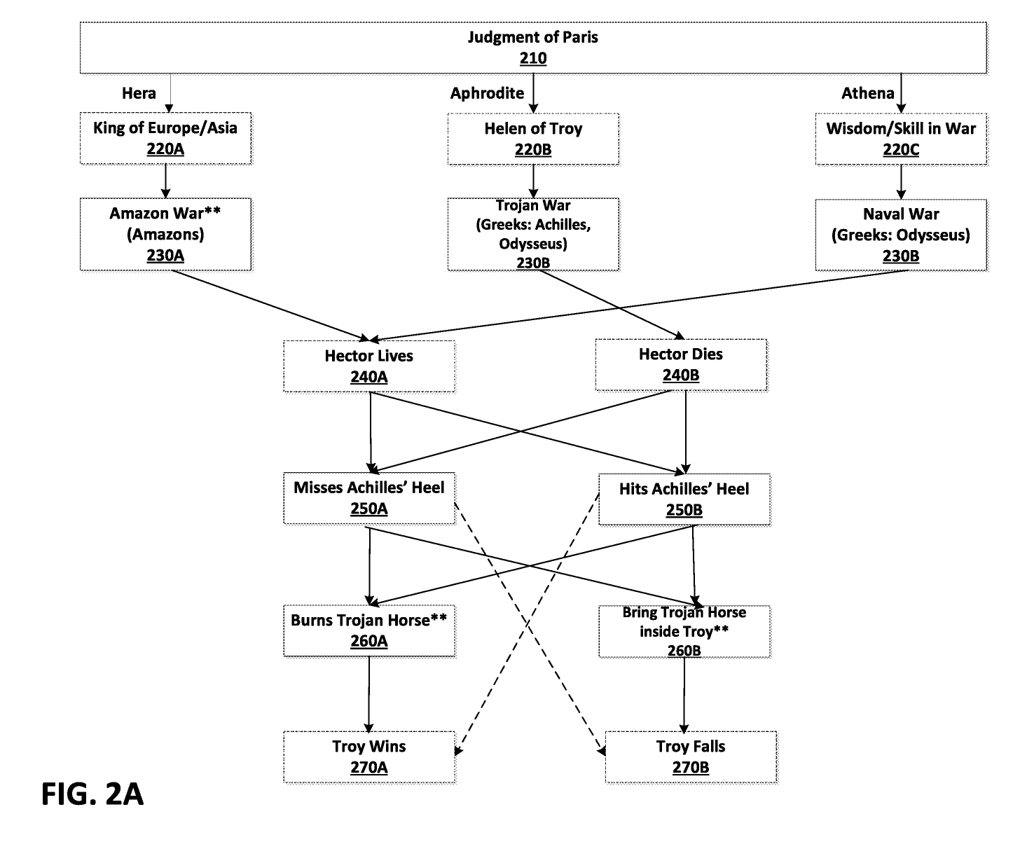

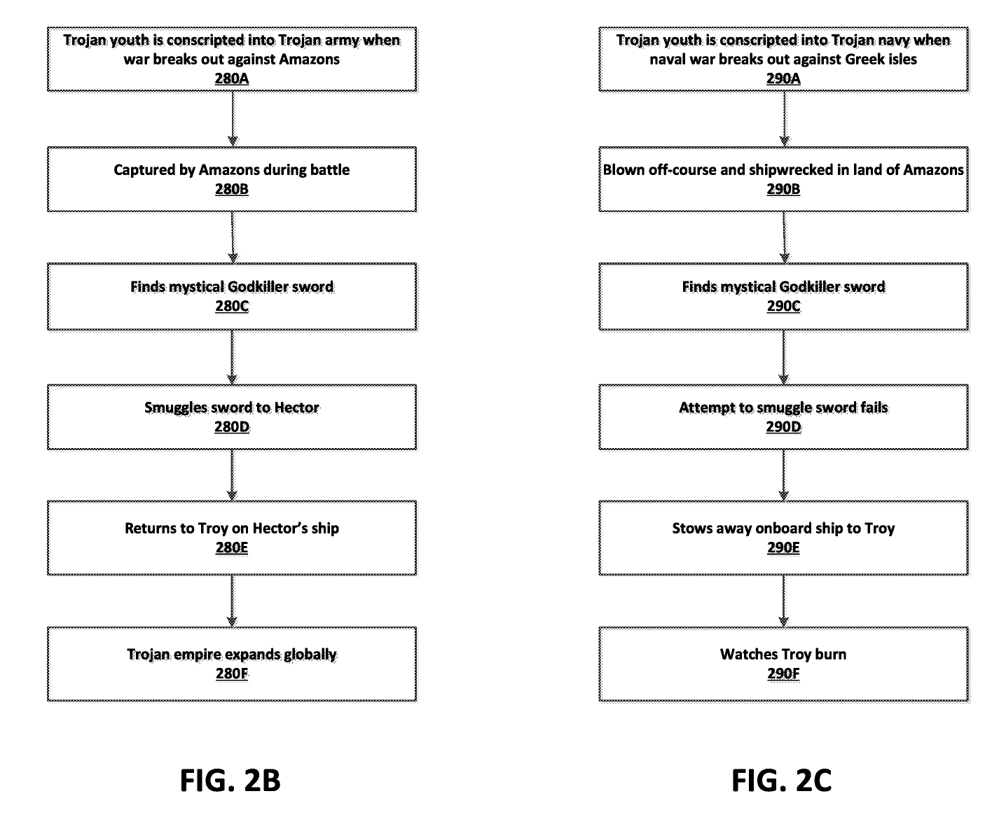

FIG. 2A illustrates an exemplary narrative map with a set of decision points that may be available in a game title. As illustrated, the game title based on the Trojan War may follow a narrative that is driven by the player, whether by making certain choices, taking certain in-game actions, or achieving certain in-game statuses. The first illustrated decision point involves the Judgment of Paris 210. The Judgment of Paris decision point 210 allows for three possible choices: Hera, Aphrodite, and Athena. Each choice is associated with certain known rewards 220A-C. For example, choosing Hera results in outcome 220A (being made king of Europe and Asia), whereas choosing Aphrodite results in outcome 220B (winning Helen of Troy), and choosing Athena results in outcome 220C (given wisdom and skill in warfare). Each decision point outcome 220A-C may lead to different decision points or may also converge on common decision points. The decision points that are available—as well as the outcomes that are available for each decision point—may be based on previous outcomes.

As illustrated, decision point outcome 220A-C leads to different options as to which war (and which opponent) is being fought. Being made king of Europe and Asia, as in decision point outcome 220A, leads to a war against the Amazons 230A, while winning Helen of Troy, as in decision point outcome 220B, leads to war against all Greeks (including Achilles and Odysseus) 230B. Finally, wisdom and skill in warfare, as in decision point outcome 220C, may weigh against getting involved in a land war in Asia, thereby resulting in a naval war against the Greek islands only (including Odysseus) 230C.

The particular war being fought 230A-C (and composition of the player's opponents) further leads to different available outcomes at different points in the narrative. For example, the absence of Achilles from the Amazon war 230A and naval war 230C means that Hector lives 240A, whereas the presence of Achilles in the Trojan war leads to Hector's death 240B. In decision point 250A-B, the player may shoot at Achilles' heel, where the possible outcomes are missing Achilles' heel 250A or hitting Achilles' heel 250B.

The availability of decision point 260A-B and outcomes involving the Trojan horse—which is a plan originated by Odysseus—may therefore depend on the particular war in which the player has engaged, which results from one or more decisions made earlier in the interactive game. Where the player is not engaged in a war against Odysseus (i.e., such as in the Amazon war 230A), the decision point as to whether to burn the Trojan horse 260A or to bring the Trojan horse inside Troy 260B may not be available to the player. Different results as to whether the city of Troy wins 270A or falls 270B against its particular opponent may result within the interactive game title.

Whereas the interactive game title may follow the narrative of a war and wartime events, the interdependent game may use such war as a backdrop for a related, but different narrative. Such interdependent narrative may take place in the same universe as the interactive game title and as such, not only remains consistent and continuous with the general environment of the game title, but is specifically based on the decisions made by the player with respect to the same.

FIG. 2B illustrates an exemplary narrative of content that may be assembled based on a set of decisions made with respect to the decision points in the narrative map of FIG. 2A. As illustrated in episode 280A, a Trojan youth may be conscripted to fight in the war against the Amazons. Such an episode 280A depends on the player reaching the Judgment of Paris decision point 210 and choosing Hera (and the kingdoms of Europe and Asia) in decision point outcome 220A, which results in the Amazon war 230A. Assembling episode 280A may therefore require filtering of different narrative elements involving the different possible backgrounds (e.g., battlegrounds) and different characters (e.g., opponents).

In episode 280B, the youth may be captured by the Amazons during battle, and in episode 280C, the youth may find a mystical Godkiller sword in the land of the Amazons. The youth may further smuggle the sword to Hector in episode 280D, return to Troy on Hector's ship in episode 280E, and drive the global expansion of the Trojan empire (driven by the Godkiller sword) in episode 280F. Such episodes 280D-E depend on Hector remaining alive 240A, which depends on whether or not Achilles is part of the wartime opposition. Further, the ability of Troy to expand in episode 280F depends on winning the war 270A and avoiding the fall of Troy 270B, whether by killing Achilles 250B or burning the Trojan horse 260A. Achilles and the Trojan horse may never actually be featured as a central character/plot point or even appear in the interdependent story of FIG. 2B, however. The decision points involving the same in the interactive game title of FIG. 2A may nevertheless affect how the interdependent story of FIG. 2B plays out.

FIG. 2C illustrates another exemplary narrative of content that may be assembled based on a different set of decisions made with respect to the decision points of FIG. 2A. In the interdependent story of FIG. 2C, episode 290A features the Trojan youth being conscripted to fight in the naval war, and episode 290B features the Trojan youth being blown off-course and shipwrecked in the land of the Amazons. Episode 290C features the Trojan youth finding the same Godkiller sword as was found in the slightly different narrative of FIG. 2B. In episode 290D, however, the attempt to smuggle the sword out of the land of the Amazons fails, and in episode 290E, the youth is forced to stow away onboard a ship to Troy. Finally, in episode 290E, the youth is unable to save Troy due to lack of the Godkiller sword and must watch Troy burn. The particular narrative of FIG. 2C share many of the same narrative elements as that of FIG. 2B, but diverges on others based on the different decision point outcomes that arise from a game session involving the game title of FIG. 2A.

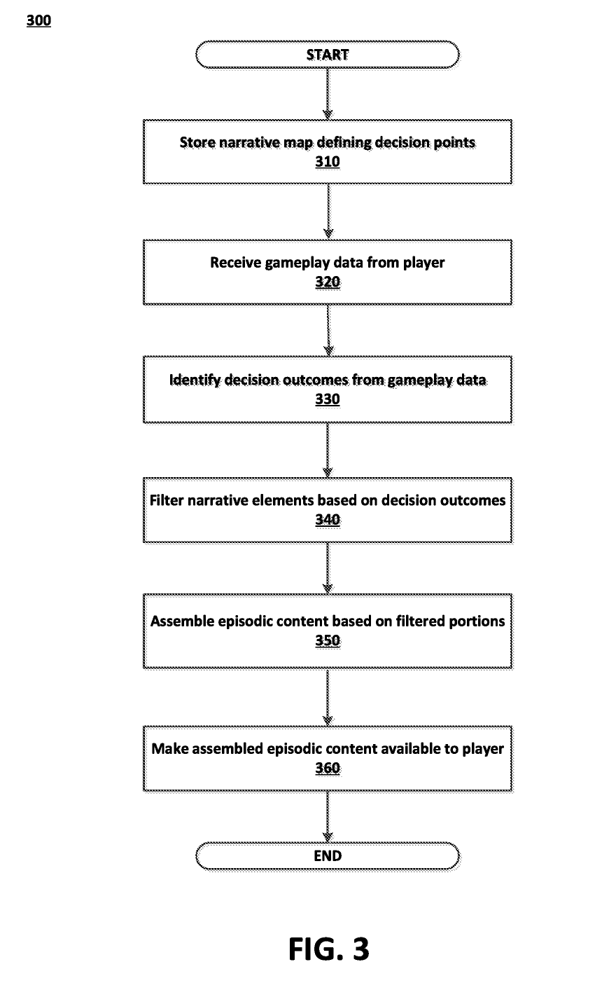

FIG. 3 illustrates a method 300 for management and assembly of interdependent content narratives. The method 00 of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

In method 300 of FIG. 3, a narrative map may be stored in memory, which identifies a plurality of decision outcomes available at a decision point within a game title where each decision outcome is associated with a set of narrative elements of an interdependent story. Tracked data regarding interaction by a player with the game title may identify when the decision point has been reached in a session, as well as a selected decision outcome. The narrative elements of the interdependent story may be filtered based on the selected decision outcome and the stored narrative map. An episode of the interdependent story may be assembled based on the filtered set of narrative elements associated with the selected decision outcome as indicated by the stored narrative map. The player may then be provided with access to the assembled episode.

In step 310, a narrative map may be stored in memory. Such narrative map may define the decision points in a game title that affect the narrative of an interdependent story (e.g., episodic miniseries). The narrative map may delineate the possible outcomes from each decision point and associate each outcome with a set of narrative elements, which may or may not be defined by reference to an exclusionary rule. FIG. 2A illustrates an exemplary narrative map with a plurality of different decision points and decision point outcomes that may be result in different narrative elements (e.g., war being fought, whether Hector lives or dies, Troy winning or falling) that may be selected and assembled into the alternative narratives of FIGS. 2B and 2C of the interdependent story.

In step 320, gameplay data may be received from player during a gameplay session. A player may use any of a variety of different client devices 150 to play an interactive game. Such gameplay data may be monitored and tracked to determine whether the decision points have been reached and the associated outcomes determined.

In step 330, the decision point outcomes may be identified from the received gameplay data. As noted herein, such outcomes may be based on selections made by the player (e.g., from options 220A-C that are available in the Judgment of Paris 210) or achievements or status reached by the player (e.g., missing 250A or hitting 250B Achilles' heel).

In step 340, a set of narrative elements may be filtered based on the identified decision point outcomes. An interdependent story may be associated with a variety of different possible narrative elements, which may result in different alternative storylines. As noted herein, the narrative elements may be visual or audio-based, as well as related to background, character, or plot. Referring back to the narrative map of FIG. 2A, a choice as to goddess in the Judgment of Paris 210 results in different wars being fought against different opponents. Such opponents may relate to different sets of narrative elements, including different images, different sounds, different battlegrounds, and different plot events. Depending on which of the different decision point outcomes occur in the player's game session, the available narrative elements may be filtered in different ways based on the narrative map, resulting in a different set of narrative elements.

In step 350, the filtered narrative elements may be assembled together into an episode or other defined portion of interdependent content. As discussed herein, some narrative elements may be common to a number of different alternative narratives under the narrative map of the interdependent story. Some narrative elements may differ, however, resulting in one player receiving a different first episode of the interdependent story than another player who made different decisions in the interactive game.

In step 360, the assembled episode may be made available to the player to stream, download, or otherwise access. Because of the way the episode is assembled based on decision point outcomes, the player may replay the interactive game title, make different decisions (or improve upon performance) at the decision points, and receive a different alternative episode or set of episodes. In some embodiments, the player may be given access to an entire feature film once all possible decision point outcomes have been identified for an interdependent story, while in other embodiments, the player may be given access to each episode or defined portion as it is assembled by way to satisfying the requisite set of decision points.

While a single interdependent story is discussed herein for each game title, multiple different interdependent stories on multiple different platforms and devices are possible for each interactive game title. Different content developers or producers may provide associated interdependent stories that rely upon a common game title, for example. Such interdependent stories may rely on the same or different decision points. Further, the multi-verse (parallel universes) of an interdependent story may relate or be independent from the multi-verse of another interdependent story associated with the same game title.

FIG. 4 is an exemplary electronic entertainment system that may be used in management and assembly of interdependent content narratives. The entertainment system 400 of FIG. 4 includes a main memory 405, a central processing unit (CPU) 410, vector unit 415, a graphics processing unit 420, an input/output (I/O) processor 425, an I/O processor memory 430, a peripheral interface 435, a memory card 440, a Universal Serial Bus (USB) interface 445, and a communication network interface 450. The entertainment system 400 further includes an operating system read-only memory (OS ROM) 455, a sound processing unit 460, an optical disc control unit 470, and a hard disc drive 465, which are connected via a bus 475 to the I/O processor 425.

Entertainment system 400 may be an electronic game console. Alternatively, the entertainment system 400 may be implemented as a general-purpose computer, a set-top box, a hand-held game device, a tablet computing device, or a mobile computing device or phone. Entertainment systems may contain more or less operating components depending on a particular form factor, purpose, or design.

The CPU 410, the vector unit 415, the graphics processing unit 420, and the I/O processor 425 of FIG. 4 communicate via a system bus 485. Further, the CPU 410 of FIG. 4 communicates with the main memory 405 via a dedicated bus 480, while the vector unit 415 and the graphics processing unit 420 may communicate through a dedicated bus 490. The CPU 410 of FIG. 4 executes programs stored in the OS ROM 455 and the main memory 405. The main memory 405 of FIG. 4 may contain pre-stored programs and programs transferred through the I/O Processor 425 from a CD-ROM, DVD-ROM, or other optical disc (not shown) using the optical disc control unit 470. I/O Processor 425 of FIG. 4 may also allow for the introduction of content transferred over a wireless or other communications network (e.g., 4G, LTE, 1G, and so forth). The I/O processor 425 of FIG. 4 primarily controls data exchanges between the various devices of the entertainment system 400 including the CPU 410, the vector unit 415, the graphics processing unit 420, and the peripheral interface 435.

The graphics processing unit 420 of FIG. 4 executes graphics instructions received from the CPU 410 and the vector unit 415 to produce images for display on a display device (not shown). For example, the vector unit 415 of FIG. 4 may transform objects from three-dimensional coordinates to two-dimensional coordinates, and send the two-dimensional coordinates to the graphics processing unit 420. Furthermore, the sound processing unit 460 executes instructions to produce sound signals that are outputted to an audio device such as speakers (not shown). Other devices may be connected to the entertainment system 400 via the USB interface 445, and the communication network interface 450 such as wireless transceivers, which may also be embedded in the system 400 or as a part of some other component such as a processor.

A user of the entertainment system 400 of FIG. 4 provides instructions via the peripheral interface 435 to the CPU 410, which allows for use of a variety of different available peripheral devices (e.g., controllers) known in the art. For example, the user may instruct the CPU 410 to store certain game information on the memory card 440 or other non-transitory computer-readable storage media or instruct a character in a game to perform some specified action.

The present invention may be implemented in an application that may be operable by a variety of end user devices. For example, an end user device may be a personal computer, a home entertainment system (e.g., Sony PlayStation2® or Sony PlayStation3® or Sony PlayStation4®), a portable gaming device (e.g., Sony PSP® or Sony Vita®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for management and assembly of interdependent content narratives, the system comprising:
a content server that stores a narrative map, wherein the narrative map identifies a plurality of decision outcomes available at a decision point within an interactive content title, each decision outcome associated with a set of narrative elements of an interdependent content title;
an interactive content server that tracks data regarding interaction by a player device with the interactive content title to identify when the decision point has been reached in a session; and
a content generation server that:
identifies that the tracked data is indicative of a selected decision outcome from the plurality of available decision outcomes;
filters the narrative elements of the interdependent content title based on the selected decision outcome and the stored narrative map;
assembles an episode of the interdependent content title based on the filtered set of narrative elements associated with the selected decision outcome as indicated by the stored narrative map; and
provides the player device with access to the assembled episode in response to a request from the player device.

2. The system of claim 1, wherein the content server further stores information regarding the interdependent content title, the stored information regarding a plurality of episodes, each episode associated with a set of one or more of the decision points.

3. The system of claim 2, wherein the content generation server further:
initially receives a request for the episode from the player;
identifies that the tracked data regarding the player interaction with the interactive content title has not yet reached at least one of the set of decision points associated with the episode; and
denies the player access to the episode.

4. The system of claim 1, wherein interaction data in a different session indicates a different selected decision outcome, and wherein the content generation server assembles a different episode from a different set of narrative elements of the interdependent content title.

5. The system of claim 1, wherein the interactive content title is played on one content platform, and wherein the episode of the interdependent content title is played on a different content platform.

6. The system of claim 1, wherein the filtered set of narrative elements associated with the selected decision outcome is further defined by an exclusionary rule regarding which narrative elements are to be excluded from the episode.

7. The system of claim 1, wherein the content generation server assembles the episode by generating at least one composite image based on the filtered set of narrative elements.

8. The system of claim 1, wherein the content generation server assembles the episode by selecting from a plurality of different alternative narrative elements.

9. The system of claim 1, wherein the selected decision outcome is based on at least one of a player selection, a player achievement, or a player status.

10. The system of claim 1, wherein the narrative elements comprise at least one of a visual element, an audio element, an environmental element, a character element, and a plot element.

11. A method for management and assembly of interdependent content narratives, the method comprising:
storing a narrative map in memory, wherein the narrative map identifies a plurality of decision outcomes available at a decision point within an interactive content title, each decision outcome associated with a set of narrative elements of an interdependent content title;
tracking data regarding interaction by a player with the interactive content title to identify when the decision point has been reached in a session;
identifying that the tracked data is indicative of a selected decision outcome from the plurality of available decision outcomes;
filtering the narrative elements of the interdependent content title based on the selected decision outcome and the stored narrative map;
assembling an episode of the interdependent content title based on the filtered set of narrative elements associated with the selected decision outcome as indicated by the stored narrative map; and
providing the player with access to the assembled episode in response to a request from the player.

12. The method of claim 11, further comprising storing information regarding the interdependent content title, the stored information regarding a plurality of episodes, each episode associated with a set of one or more of the decision points.

13. The method of claim 12, further comprising:
initially receiving a request for the episode from the player;
identifying that the tracked data regarding the player interaction with the interactive content title has not yet reached at least one of the set of decision points associated with the episode; and
denying the player access to the episode.

14. The method of claim 11, wherein interaction data in a different session indicates a different selected decision outcome, and wherein a different episode is assembled from a different set of narrative elements of the interdependent content title.

15. The method of claim 11, wherein the interactive content title is played on one content platform, and wherein the episode of the interdependent content title is played on a different content platform.

16. The method of claim 11, wherein the filtered set of narrative elements associated with the selected decision outcome is further defined by an exclusionary rule regarding which narrative elements are to be excluded from the episode.

17. The method of claim 11, wherein assembling the episode comprises generating at least one composite image based on the filtered set of narrative elements.

18. The method of claim 11, wherein assembling the episode comprises selecting from a plurality of different alternative narrative elements.

19. The method of claim 11, wherein the selected decision outcome is based on at least one of a player selection, a player score, or a player achievement.

20. The method of claim 11, wherein the narrative elements comprise at least one of a visual element, an audio element, an environmental element, a character element, and a plot element.

21. A non-transitory computer-readable storage medium, having embodied thereon a program executable by a processor to perform a method for management and assembly of interdependent content narratives, the method comprising:
storing a narrative map in memory, wherein the narrative map identifies a plurality of decision outcomes available at a decision point within an interactive content title, each decision outcome associated with a set of narrative elements of an interdependent content title;
tracking data regarding interaction by a player with the interactive content title to identify when the decision point has been reached in a session;
identifying that the tracked data is indicative of a selected decision outcome from the plurality of available decision outcomes;
filtering the narrative elements of the interdependent content title based on the selected decision outcome and the stored narrative map;
assembling an episode of the interdependent content title based on the filtered set of narrative elements associated with the selected decision outcome as indicated by the stored narrative map; and
providing the player with access to the assembled episode in response to a request from the player.
